(19) United States
(12) Patent Application Publication
(10) Pub. No.: US 2009/0121686 A1
(43) Pub. Date: May 14, 2009

(54) POWER SAVING CHARGER

(76) Inventor: Rober Lo, Taichung (TW)

Correspondence Address: ROBER LO;235 Chung - Ho, Box 8-24, Taipei, TW

(21) Appl. No.: 11/938,765

(22) Filed: Nov. 12, 2007

(51) Int. Cl. H02J 7/02; G05F 3/02

(52) U.S. Cl. 320/162; 327/544

(57) ABSTRACT

A power saving charger comprises a switch circuit having an input end connected to an AC current source for turning on or turn off AC current; a switch driving circuit having an output end connected to the switch circuit for outputting signals to turn on or turn off the AC current of the switch circuit; a charging circuit connected to the output end of the switch circuit for converting AC current to DC current so as to charge to a battery of an external load; and a charge detection circuit connected to a charge output end of the charging circuit and a signal output end of the charging circuit for detection the completeness of the charge and detection of the existence of the load; and a signal output end of the charge detection circuit being connected to an signal input end of the switch driving circuit.

### FIELD OF THE INVENTION

The present invention relates to power saving technology, and particularly to a power saving charger which can provide a function of no power consumption as the electric device with the present invention is not charged.

### BACKGROUND OF THE INVENTION

With the improvement of technology, more and more electronic devices are developed and used. It is often that theses electronic devices are connected to receptacles for charging, even the battery is sufficient power. However as this state, the batteries of the devices still consume power. For example for a handset connected to a receptacle, it sill consumes a power rate of 0.15 to 0.6 Watt per hour as the voltage is 110 AC. An average of 0.375 Watt per hour exists. If it is inserted thereon for 24 hours, the power consumption is 9 watts. This can be converted as 3285 Watts per year. There are about 1 billion handsets in the earth. Thus a large amount power is wasted.

Other then handset, Notebook computers, PDAs, digital cameras, IPODs, and other electronic devices are widely used. Thus the wasted power is a very great value. Thereby there is an eager demand for a novel design which can improve such problem.

### SUMMARY OF THE INVENTION

Accordingly, the primary object of the present invention is to provide a power saving charger which can provide a function of no power consumption as the electric device with the present invention is not charged.

To achieve above objects, the present invention provides a power saving charger comprising: a switch circuit having an input end connected to an AC current source for turning on or turn off AC current; a switch driving circuit having an output end connected to the switch circuit for outputting signals to turn on or turn off the AC current of the switch circuit; a charging circuit connected to the output end of the switch circuit for converting AC current to DC current so as to charge to a battery of an external load; and a charge detection circuit connected to a charge output end of the charging circuit and a signal output end of the charging circuit for detection the completeness of the charge and detection of the existence of the load; a signal output end of the charge detection circuit being connected to an signal input end of the switch driving circuit; wherein is usage, the battery of the external load is connected to the charging circuit and a charge output end of the load is connected to the charge detection circuit.

The power saving operation according to the present invention will be described herein.

The operation of the present invention is that when the battery of the load is connected to the output end of the charging circuit, as a lower power signal is outputted from the signal output end of the load to the signal input end of the switch driving circuit, the switch driving circuit will output a control signal to actuate the switch circuit to input AC current to the charging circuit and the AC current is converted into DC current to charge the battery of the load. When the power output end of the load outputs charge complete signals to the switch driving circuit, the switch driving circuit will output control signals to the switch circuit to turn off the AC current. In the charge process, by the charge detection circuit to detect whether the load has been removed, if it is removed, then the signal output end of the charge detection circuit will output a signal to the switch driving circuit to device turn off the switch circuit so that no AC current is transferred.

The various objects and advantages of the present invention will be more readily understood from the following detailed description when read in conjunction with the appended drawing.

### BRIEF DESCRIPTION OF THE DRAWINGS

FIG. 1 is a block diagram showing the structure of the present invention.

FIG. 2 is a schematic view showing the connection of the present invention with a load.

FIG. 3 shows the first application of the present invention.

FIG. 4 shows the second application of the present invention.

FIG. 5 shows the third application of the present invention.

FIG. 6 shows the fourth application of the present invention.

FIG. 7 shows the fifth application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

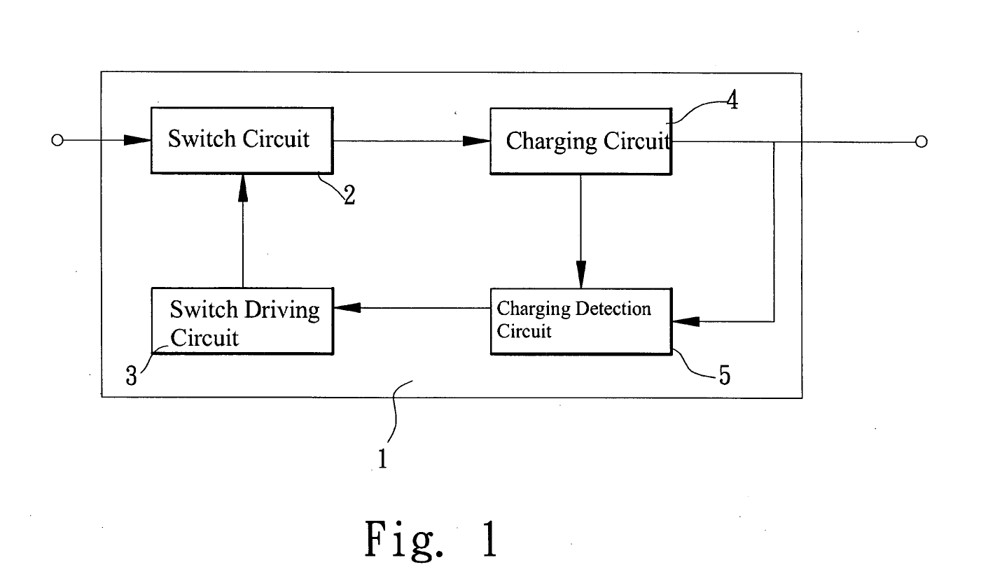

Referring to FIGS. 1, the structural block diagram of the present invention is illustrated. The power saving charger 1 of the present invention has the following elements.

A switch circuit 2 has an input end connected to an AC current source for turning on or off AC current;

A switch driving circuit 3 has an output end connected to the switch circuit 2 for outputting signals to turn on or turn off the switch circuit 2 for inputting AC current.

A charging circuit 4 is connected to the output end of the switch circuit 2 for converting AC current to DC current so as to charge to a battery of an external load.

A charge detection circuit 5 is connected to a charge output end of the charging circuit 4 and a signal output end of the charging circuit 4 for detection the completeness of the charge and detection of the existence of the load. A signal output end of the charge detection circuit 5 is connected to a signal input end of the switch driving circuit 3.

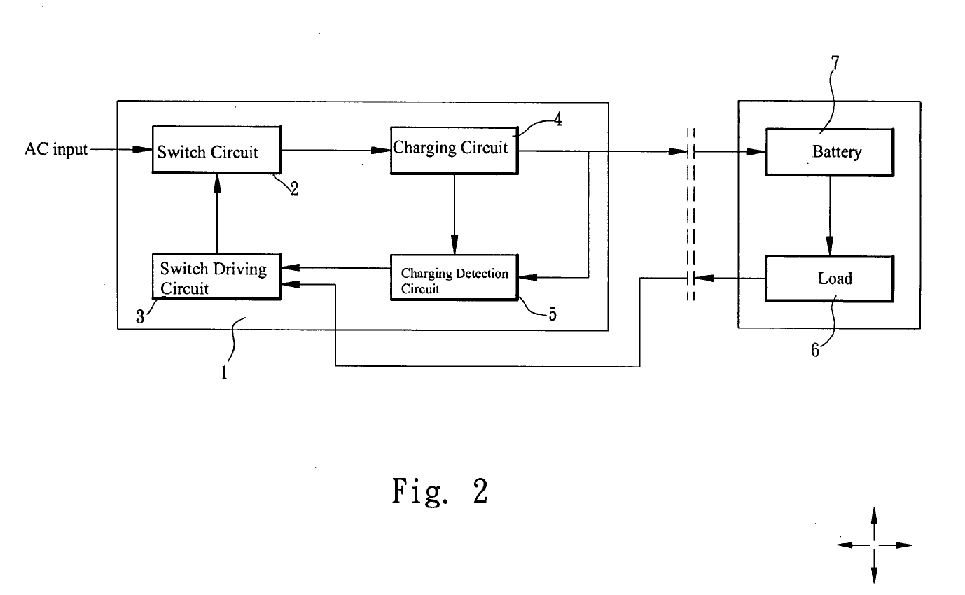

Referring to FIG. 2, it is illustrated that a load 6 is connected to a battery 7. The charge signal output end of the load 6 is connected to a signal input end of the switch driving circuit 3.

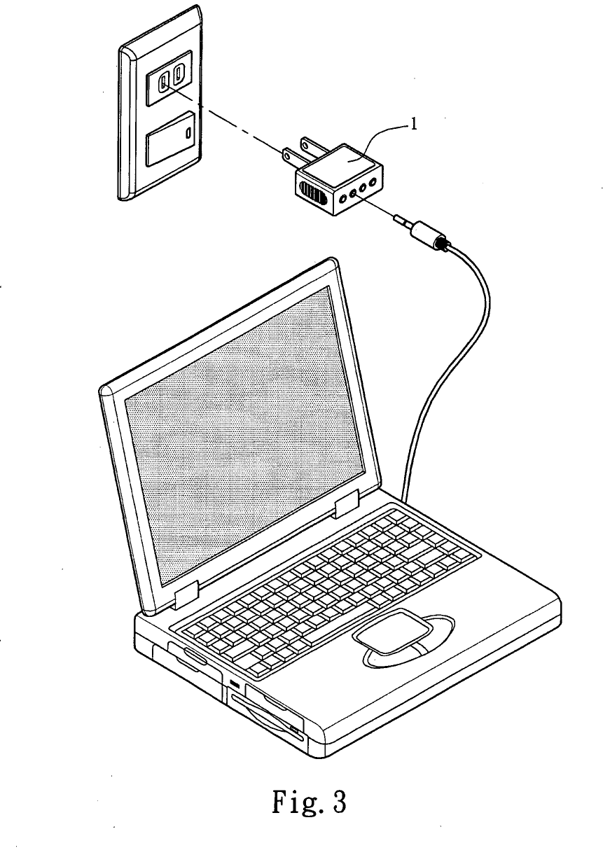

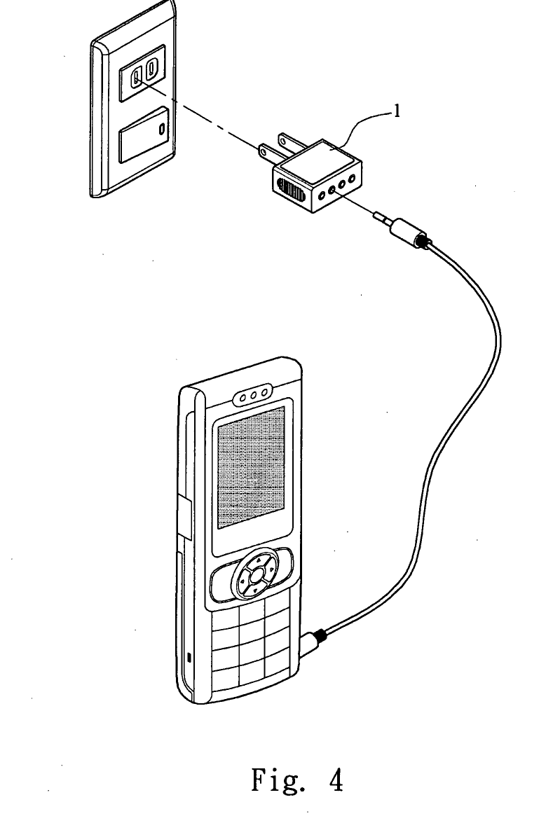

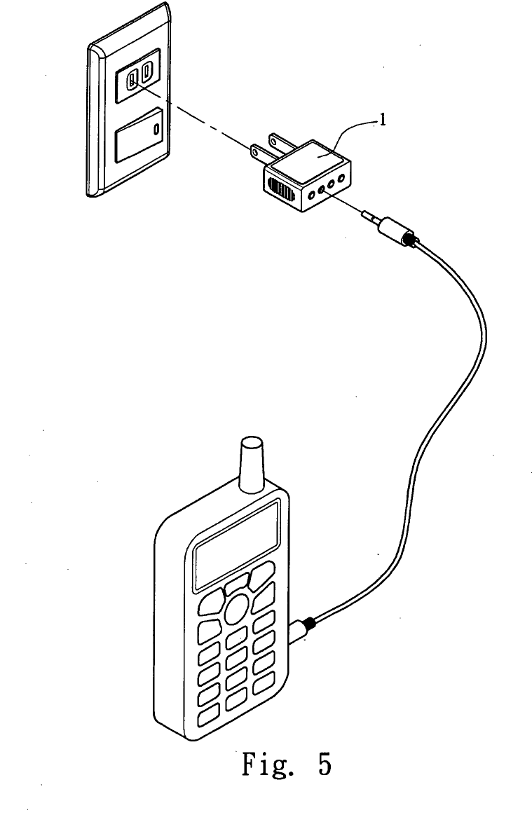

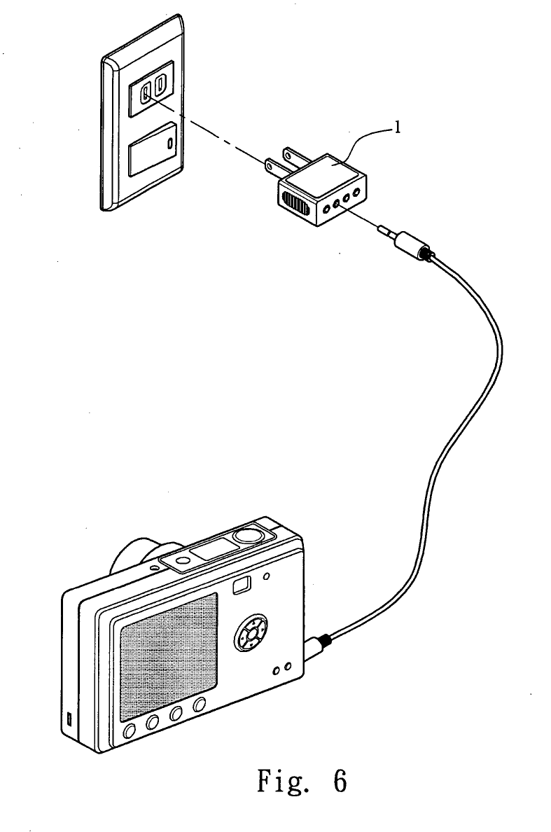

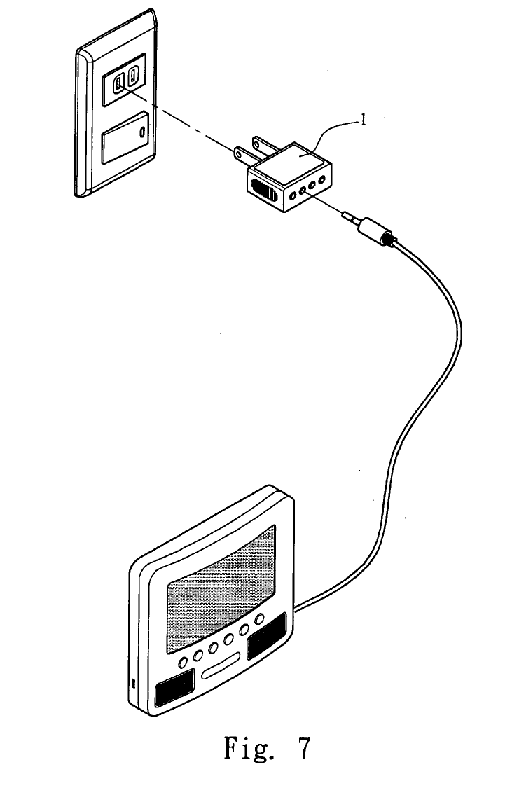

In the present invention, the load 6 is an electronic device with a battery, such as a Notebook computer, a PDA, a handset, a digital camera, an IPOD, etc., as illustrated in FIGS. 3 to 7.

The power saving operation according to the present invention will be described herein. (A) When the battery 7 of the load 6 is connected to the output end of the charging circuit 4 of the present invention, as a lower power signal is outputted from the signal output end of the load 6 to the signal input end of the switch driving circuit 3, the switch driving circuit 3 will output a control signal to actuate the switch circuit 2 to input AC current to the charging circuit 4 and the AC current is converted into DC current to charge the battery 7 of the load 6.

(B) When the power output end of the load 6 outputs charge complete signals to the switch driving circuit 3, the switch driving circuit 3 will output control signals to the switch circuit 2 to turn off the AC current.

(C) In the charge process, by the charge detection circuit 5 to detect whether the load 6 has been removed, if it is removed, then the signal output end of the charge detection circuit 5 will output a signal to the switch driving circuit 3 to device turn off the switch circuit 2 so that no AC current is transferred.

By above mentioned process, in the present invention, as the charging process in the load 6 is complete, or no load is connected, the AC current will turn off so that no power is wasted.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A power saving charger 1 of the present invention has the following elements.
a switch circuit having an input end connected to an AC current source for turning on or turn off AC current;
a switch driving circuit having an output end connected to the switch circuit for outputting signals to turn on or turn off the AC current of the switch circuit;
a charging circuit connected to the output end of the switch circuit for converting AC current to DC current so as to charge to a battery of an external load; and
a charge detection circuit connected to a charge output end of the charging circuit and a signal output end of the charging circuit for detecting the completeness of the charge and detection of the existence of the load; a signal output end of the charge detection circuit being connected to an signal input end of the switch driving circuit; and
wherein is usage, the battery of the external load is connected to the charging circuit and a charge output end of the load is connected to the charge detection circuit.
